(19) United States
(12) Patent Application Publication
(10) Pub. No.: US 2019/0378641 A1
(43) Pub. Date: Dec. 12, 2019

(54) INDUCTOR AND INDUCTOR MANUFACTURING METHOD

(71) Applicant: SAMSUNG ELECTRONICS CO., LTD., Suwon-si, Gyeonggi-do (KR)

(72) Inventor: Jeong Il KANG, Yongin-si, Gyeonggi-do (KR)

(21) Appl. No.: 16/477,295

(22) PCT Filed: Sep. 27, 2017
(86) PCT No.: PCT/KR2017/010655

§ 371 Date: Jul. 11, 2019

(30) Foreign Application Priority Data
Jan. 26, 2017 (KR) 10-2017-0012457

(51) Int. Cl. H01F 27/02; H01F 27/30; H01F 27/32; H01F 37/00; H01F 17/04; H01F 41/06; H01F 27/29; H01F 27/28

(52) U.S. Cl. CPC H01F 27/02; H01F 27/30; H01F 27/32; H01F 37/00; H01F 2017/048; H01F 41/06; H01F 27/292; H01F 27/2823; H01F 17/04

(57) ABSTRACT

An inductor and a method of manufacturing the same are provided. The inductor according to an embodiment of the disclosure includes a winding wire including opposite end portions spaced away from each other and a housing fixing at least a part of a rest of the winding wire. The housing is formed through injection molding including positioning the winding wire inside a mold to expose the opposite end portions, injecting plastic resin into an inner space of the mold, and solidifying the resin.

### TECHNICAL FIELD

Various embodiments of the disclosure relate to an inductor for high voltage and a method of manufacturing the same.

### BACKGROUND ART

A winding wire of a conventional high-voltage inductor may be formed by winding a conducting wire on a bobbin having a plurality of pins and soldering opposite end portions of the conducting wire at the plurality of pins of the bobbin. Further, the conventional high voltage inductor may improve inductor performance as a magnetic inductor is fixed to the bobbin coupled to the conducting wire using a tape or an adhesive. Then, in the conventional high voltage inductor, an insulating tape has prevented the conducting wire coupled to the bobbin from being externally exposed.

### DISCLOSURE

### Technical Problem

The conventional high-voltage inductor where the conducting wire is soldered to the bobbin has been soldered to a printed circuit board in an automated process (surface mounting technology: SMT). Therefore, in the conventional high voltage inductor, soldering defect rate is high in manual and automated soldering processes to generate noise during operation.

In addition, in the conventional high voltage inductor, because the insulating tape prevents the conducting wire from being externally exposed, the conducting wire may be exposed due to poor adhesion of the tape, and therefore there is a possibility that the conducting wire is damaged due to an external factor.

Various embodiments of the disclosure may provide an inductor capable of easily protecting and fixing a conducting wire included therein and a method of manufacturing the same.

### Technical Solution

An inductor according to an embodiment of the disclosure includes a winding wire that has a specific shape, and a housing that exposes opposite end portions of the winding wire and fixes at least of a rest of the winding wire in the housing. Each of the opposite end portions is a region having a specific length from each of opposite edge sides of the winding wire, and the housing includes a nonmagnetic material having a nonconductive property.

A method of manufacturing an inductor according to an embodiment of the disclosure includes forming a winding wire by winding a conducting wire to have a specific shape, and forming a housing fixing at least a part of a rest of the winding wire except for opposite end portions of the winding wire in the housing. Each of the opposite end portions is a region having a specific length from each of opposite edge sides of the winding wire, and the forming of the housing includes seating the at least of the rest of the winding wire in a mold to expose the opposite end portions of the winding wire and performing injection molding using the mold, which includes the winding wire.

### Advantageous Effects

According to the disclosure, a conducting wire included in an inductor may be easily protected and fixed.

### DESCRIPTION OF DRAWINGS

FIG. 1 is an exploded view of an inductor according to an embodiment of the disclosure;

FIG. 2A is an upper perspective view of an inductor according to various embodiments of the disclosure;

FIG. 2B is a bottom perspective view of an inductor according to an embodiment of the disclosure;

FIG. 3 is a view illustrating a winding wire according to an embodiment of the disclosure;

FIG. 4A is a cross-sectional view of a top perspective view of a housing according to an embodiment of the disclosure;

FIG. 4B is a top perspective view of a housing according to an embodiment of the disclosure;

FIG. 4C is a bottom perspective view of a housing according to an embodiment of the disclosure;

FIG. 4D is a bottom perspective view of a housing with a plurality of dummy pins according to an embodiment of the disclosure;

FIG. 5 is a view illustrating a magnetic coil according to an embodiment of the disclosure;

FIG. 6A is a perspective view of a winding wire according to an embodiment of the disclosure;

FIG. 6B illustrates a winding wire disposed in a first mold according to an embodiment of the disclosure;

FIG. 6C illustrates first and second molds forming a housing according to an embodiment of the disclosure;

FIG. 6D is a top perspective view and a bottom perspective view of a housing according to an embodiment of the disclosure;

FIG. 6E is a bottom perspective view of a housing with dummy pins according to an embodiment of the disclosure;

FIG. 6F is a view showing a process of bending opposite end portions of a winding wire according to an embodiment of the disclosure;

FIG. 6G is a view illustrating a coupling process of a housing and a magnetic core according to an embodiment of the disclosure; and

FIG. 7 is a flowchart illustrating a method of manufacturing an inductor according to an embodiment.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the various embodiments may be used to refer to various components regardless of the order, but do not limit the components. For example, “a first user device” and “a second user device” indicate different user devices regardless of the order or priority. For example, without departing the scope of the disclosure, a first component may be referred to as a second component, and similarly, a second component may be referred to as a first component.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when an component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

Hereinafter, electronic devices according to various embodiments will be described with reference to the accompanying drawings. In the disclosure, the term “user” may refer to a person who uses an electronic device or may refer to a device (e.g., an artificial intelligence electronic device) that uses the electronic device.

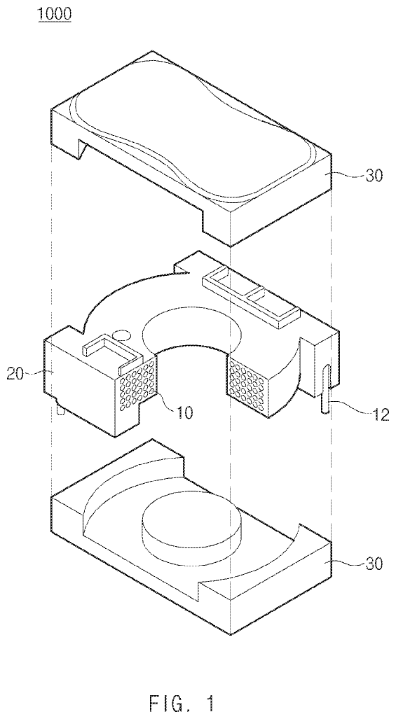

FIG. 1 is an exploded view of an inductor according to an embodiment of the disclosure. In an embodiment, in FIG. 1, a quarter of a housing 20 is cut for illustrating a coupling structure of a winding wire 10 and the housing 20.

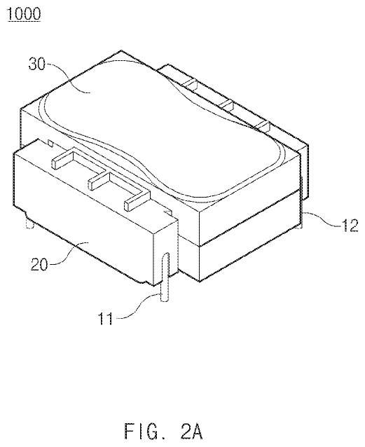

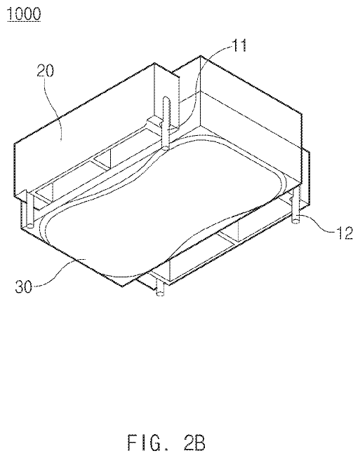

Referring to FIGS. 1 to 2B, an inductor 1000 according to an embodiment may include the winding wire 10, the housing 20, and a magnetic core 30.

According to an embodiment, the winding wire 10 may be formed by winding a self-bonding wire such that opposite end portions 11 and 12 of the winding wire are exposed to the outside. For example, the winding wire may be formed by winding the self-bonding wire using a frame member (e.g., a reel of an automatic winding machine) to have a specific shape (e.g., a donut shape) and a specific length and then separating the wire wound with the specific shape and length from the frame member. The self-bonding wire is, for example, a wire which are in contact with each other while wound with the specific shape as an adhesive may be applied to a surface of the self-bonding wire.

According to an embodiment, the winding wire 10 may include the opposite end portions (e.g., 11, 12) of the winding wire which are not included in the housing 20 and at least a part of the rest of the winding wire 10 which is included in the housing 20. In an embodiment, each of the opposite end portions (e.g., 12) of the winding wire may be a region having a specific length (e.g., 3 mm) from an edge side of the winding wire 10. Only the first end 12 of the winding wire may be illustrated in FIG. 1 because a part of the housing 20 is shown to be abbreviated but a second end (e.g., 11 of FIG. 2A) of the winding wire may be disposed at a region facing to the first end 12 of the winding wire 10 (see FIGS. 2A and 2B). In an embodiment, the at least of a part of the rest of the winding wire 10 may be the entire winding wire 10 except for the opposite end portions 12 of the winding wire. Alternatively, the at least of a part of the rest of the winding wire 10 may be more than half of the winding wire 10 except for the opposite end portions 12 of the winding wire. The shape and length of the winding wire 10 may be determined based on a characteristic experiment of the inductor 1000 according to an embodiment. Hereinafter, for the sake of convenience of explanation, the case where the winding wire has the donut shape will be described as an example.

According to an embodiment, the opposite end portions (e.g., 12) of the winding wire may be configured as pins of the inductor 1000 not to have other members (e.g., pins of a bobbin in the conventional inductor). For example, after being mounted on (or inserted into) pads (or holes) disposed at a printed circuit board, the opposite end portions (e.g., 12) of the winding wire may be soldered to the printed circuit board by an automated or manual process to be electrically connected to the circuit board. As described above, in an embodiment, the opposite end portions of the winding wire may be used as the inductor pins to reduce occurrence of poor contact of the inductor pins and poor soldering.

According to an embodiment, the opposite end portions (e.g., 12) of the winding wire may be self-soldered before being mounted on the printed circuit board. The self-soldering of the opposite end portions (e.g., 12) of the winding wire may be better than soldering in a surface mounting technology (SMT) after the inductor 1000 or the opposite end portions (e.g., 12) are mounted on the printed circuit board.

According to an embodiment, the opposite end portions (e.g., 12) of the winding wire may be bent toward a mounting direction of the printed circuit board. The bending process may include, for example, bending the opposite end portions of the winding wire in a specific direction (e.g., the mounting direction).

According to an embodiment, the housing 20 may be formed to internally protect, fix, and insulate the at least a part of the rest of the winding wire except for the opposite end portions (e.g., 12) of the winding wire. For example, the housing 20 may be formed through injection molding using a mold at which the at least a part of the rest of the winding wire 10 except for the opposite end portions (e.g., 12) of the winding wire is disposed. The at least a part of the rest of the winding wire 10 may be disposed inside the mold for injection molding of the housing 20 and the opposite end portions (e.g., 12) of the winding wire may be exposed to the outside of the mold. Then, a plastic resin may be injected into the mold where the winding wire 10 is located and may be solidified to form the housing 20. Thus, in an embodiment, the housing 20 may include, fix, and insulate the at least a part of the rest of the winding wire to prevent breakage of the conducting wire due to an external factor and to prevent generation of noise due to vibration during operation of the inductor.

According to an embodiment, the resin may be a nonmagnetic material having a nonconductive property and may be, for example, a polymer compound material. Thus, in an embodiment, a problem, that the housing 20 affects the performance of the conducting wire, may be prevented.

According to an embodiment, the resin of the housing 20 and the material of the winding wire 10 may be made of a material which is not damaged by injection molding. For example, the winding wire 10 may be made of a material having a higher melting point than a melting point of the housing 20. As described above, in an embodiment, because the winding wire 10 having the higher melting point than that of the resin of the housing is used, damage to the winding wire may be prevented during the injection molding process.

According to an embodiment, the injection molding using the winding wire 10 and the housing 20 may be performed such that a sheath of the winding wire 10 may be not damaged. For example, when the sheath of the winding wire 10 is made of a material having a first melting point and the resin of the housing 20 is made of a material having a second melting point (<the first melting point), the injection molding may be performed at a temperature above the second melting point and below the first melting point. Thus, in an embodiment, the winding wire 10 and the housing 20 may be made of materials different from each other in melting point and the temperature of the injection molding may be controlled, thereby preventing damage of the winding wire during the injection molding process.

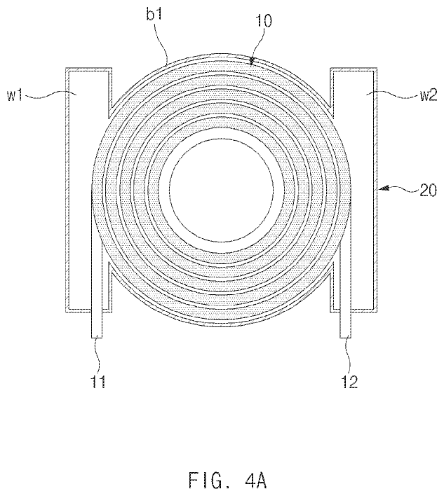

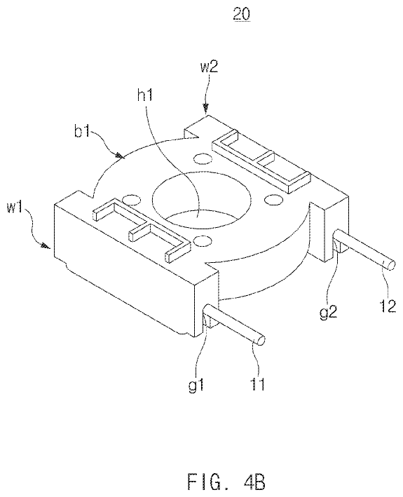

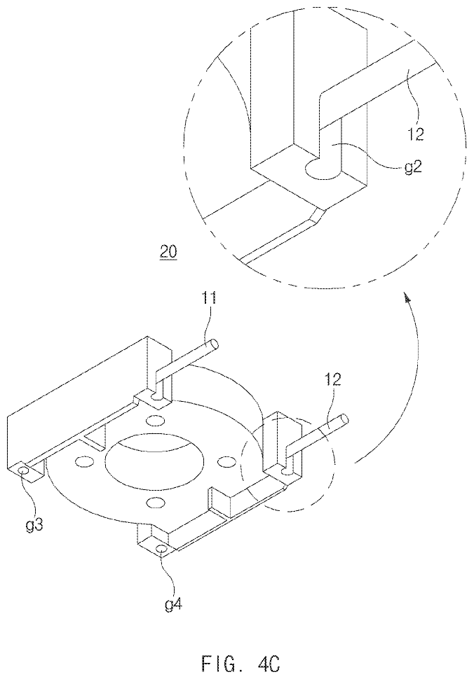

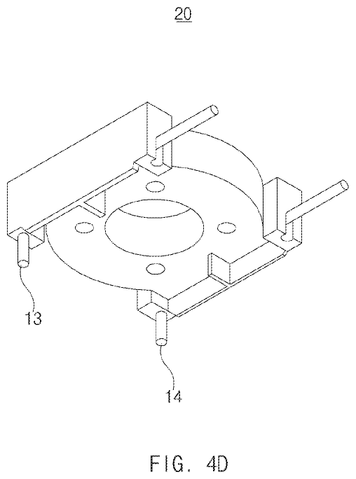

According to an embodiment, the housing 20 may be formed to have a shape and a size which are capable of including, fixing, and protecting the at least a part of the rest of the winding wire 10 except for the opposite end portions (e.g., 12) of the winding wire. For example, the housing 20 may include a plurality of grooves on which the opposite end portions (e.g., 12) of the winding wire are seated. When the opposite end portions (e.g., 12) of the winding wire are bent, the plurality of grooves may be provided at positions where the bent opposite end portions (e.g., 12) of the winding wire are seated. For another example, the housing 20 may include a dummy pin for fixing the inductor 1000 on the printed circuit board in addition to the opposite end portions (e.g., 12) of the winding wire. Details of the housing 20 will be described later with reference to FIGS. 4A to 4D.

According to an embodiment, the magnetic core 30 may cover the at least a part of the winding wire 10 except for the opposite end portions (e.g., 12) of the winding wire. Because the magnetic core 30 is a conductive material, the magnetic core 30 may be fixed to the housing 20 to be spaced apart from the opposite end portions (e.g., 12) of the winding wire by a specific distance. As described above, the magnetic core 30 may be installed in the housing 20 to be connected to the winding wire 10, thereby improving performance of the inductor 1000.

FIG. 2A is an upper perspective view of an inductor according to an embodiment of the disclosure and FIG. 2B is a bottom perspective view of an inductor according to an embodiment of the disclosure.

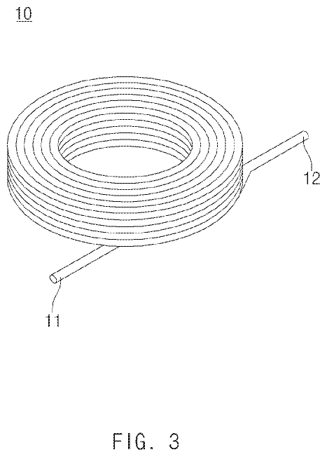

Referring to FIGS. 2A and 2B, the opposite end portions 11 and 12 of the winding wire according to an embodiment may be exposed to the outside from the housing 20 and a region except for the opposite end portions 11 and 12 of the winding wire may be included inside the housing 20. The magnetic core 30 according to an embodiment may cover at least a part of a center, two sides, an upper surface, or a lower surface of the housing 20. Hereinafter, each component of the inductor 1000 according to an embodiment of the disclosure will be described with reference to FIGS. 3 to 5.

FIG. 3 is a view illustrating a winding wire according to an embodiment of the disclosure.

Referring to FIG. 3, according to an embodiment, the winding wire 10 may be formed by winding the self-bonding wire using the frame member (e.g., a reel of an automatic winding machine) to have the specific length, and then separating the conducting wire wound with the specific shape from the frame member. The entire length (or the specific length), the cross sectional area (or a diameter), and the shape of the winding wire 10 may be determined based on the characteristics (e.g., inductance) of the inductor 1000. The shape of the winding wire 10 may vary, but hereinafter, a case where the winding wire 10 is formed in a donut shape will be described as an example.

According to an embodiment, the opposite end portions 11 and 12 of the winding wire 10 may protrude from the shape (e.g., the donut shape) of the at least a part of the rest of the winding wire 10. For example, the at least a part of the rest of the winding wire may include at least a part of the rest of the winding wire 10 except for the opposite end portions 11 and 12 of the winding wire 10 in the entire winding wire 10. For example, the opposite end portions of the winding wire 10 may protrude toward a direction in which a cross-sectional area of the specific shape formed by the at least a part of the winding wire 10 becomes larger. For another example, the opposite end portions 11 and 12 of the winding wire may protrude toward a direction in which the cross-sectional area of the specific shape becomes larger and may protrude in directions opposite to each other (e.g., a direction of FIG. 3). For still another example, the opposite end portions 11 and 12 of the winding wire may be spaced apart from each other by a specific distance as shown in FIG. 3. Thus, in an embodiment, a problem, that the opposite end portions of the winding wire are electrically in contact with each other, may be prevented.

Hereinafter, the housing according to an embodiment disclosed in the disclosure will be described with reference to FIGS. 4A to 4D. Referring to FIGS. 4A to 4D, according to an embodiment, the housing 20 may include a body b1 and wings w1 and w2.

FIG. 4A is a cross-sectional view of a top perspective view of a housing according to an embodiment of the disclosure.

Referring to FIG. 4A, according to an embodiment, the body b1 may form a curved side of the housing 20 and the wings w1 and w2 may form a straight side of the housing 20. In an embodiment, the at least a part of the rest of the winding wire 10 except for the opposite end portions 11 and 12 of the winding wire may be fixed to the body bl. A part of an outer potion of the winding wire 10 and the opposite end portions 11 and 12 of the winding wire having a straight shape may be fixed to the wings w1 and w2. According to an embodiment, the at least a part of the rest of the winding wire 10 except for the opposite end portions 11 and 12 of the winding wire may be embedded inside and fixed to the housing 20 to prevent breakage of the conducting wire due to an external factor and to prevent generation of noise due to vibration during operation of the inductor.

FIG. 4B is a top perspective view of a housing according to an embodiment of the disclosure. FIG. 4C is a bottom perspective view of a housing according to an embodiment of the disclosure and FIG. 4D is a bottom perspective view of a housing with a plurality of dummy pins according to an embodiment of the disclosure.

Referring to FIGS. 4B and 4C, according to an embodiment, at least a part of the side of the body b1 may be formed to have a curved surface and at least a part of upper and lower surfaces of the body b1 may be formed to have a planar surface. An opening h1 may be formed at a center of the body b1 and the opening h1 may be formed in a circular shape having a diameter smaller than a diameter of an area where the winding wire is not formed. At least a part of the body b1 may be connected to and coupled to the magnetic core 30. For example, the upper surface, lower surface, and the side surface of the body b1 may be connected to the magnetic core 30 (see FIG. 1).

Referring to FIGS. 4B and 4C, according to an embodiment, the wings w1 and w2 may form the straight surfaces of the housing 20 and at least a part of the upper surface, lower surface and side surface of each of the wings w1 and w2 may be formed with a straight line. In an embodiment, a plurality of the wings w1 and w2 may be coupled to the body b1 to mutually correspond to each other with respect to the body b1.

Referring to FIGS. 4B and 4C, according to an embodiment, a plurality of first grooves g1 and g2 and at least one second grooves g3 and g4 may be formed in corner regions of the wings w1 and w2. The plurality of first grooves g1 and g2 may be formed adjacent to regions where the opposite end portions 11 and 12 of the winding wire are exposed. The plurality of first grooves g1 and g2 which is bent in a direction in which the opposite end portions 11 and 12 of the winding wire are mounted on the printed circuit board (hereinafter, a mounting direction) may provide a space to be seated. For example, the first grooves g1 and g2 may be formed in spaces perpendicular to a direction in which each end portion of the winding wire 10 protrudes from the housing 20. Alternatively, the first grooves g1 and g2 may be formed to have spaces in which at least a part of an cross-sectional side of the winding wire 10, for example, a half of the cross-sectional side of the winding wire 10, is seated. To this end, according to an embodiment, when the opposite end portions 11 and 12 of the winding wire protruding from the housing 20 is not formed (or does not protrude) in the mounting direction of the printed circuit board, the opposite end portions 11 and 12 of the winding wire may be bent in a direction approaching the first grooves g1 and g2 to be seated in the first grooves g1 and g2. In an embodiment, the opposite end portions 11 and 12 of the winding wire, which are bent and seated in the first grooves g1 and g2, may be fixed to the housing 20 using an adhesive or the like. Thus, in an embodiment, the opposite end portions 11 and 12 of the winding wire may be directly mounted on the printed circuit board and may be soldered to the printed circuit board to reduce the poor contact or poor soldering as compared with the conventional inductor.

Referring to FIGS. 4C and 4D, according to an embodiment, at least one of the second grooves g3 and g4 (or a second hole) may be formed in the corner regions of the wings w1 and w2. For example, the second grooves g3 and g4 may be provided on the lower surface of the corner regions of the wings w1 and w2 where the first grooves g1 and g2 are not formed.

According to an embodiment, dummy pins 13 and 14 may be installed in the second grooves g3 and g4 and may be mounted on the printed circuit board with the opposite end portions 11 and 12 of the winding wire to support the inductor 1000. For example, the dummy pins 13 and 14 may be installed in the second grooves g3 and g4, which are provided at the lower surfaces of the corner regions of the wings w1 and w2, in a direction from a bottom to a top of each of the second grooves g3 and g4,.

In an embodiment, each of the dummy pins 13 and 14 may be identical or similar thickness to each of the opposite end portions 11 and 12 of the winding wire. Each of the dummy pins 13 and 14 may have a length corresponding to each of the opposite end portions 11 and 12 of the winding wire exposed to the outside of the housing 20. For example, the length of each of the dummy pins 13 and 14 may be identical or similar to a distance between each of the opposite end portions 11 and 12 of the winding wire bent and each of the lower surfaces of the wings w1 and w2. The dummy pins 13 and 14 and the second grooves g3 and g4 may be omitted when the opposite end portions 11 and 12 of the winding wire face the mounting direction of the printed circuit board before the bending process. Thus, the inductor 1000 according to an embodiment may be stably fixed to the printed circuit board by using the opposite end portions 11 and 12 of the winding wire and the dummy pins 13 and 14.

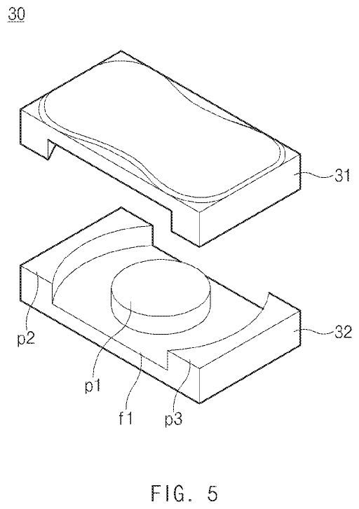

FIG. 5 is a view illustrating a magnetic coil according to an embodiment of the disclosure.

Referring to FIG. 5, the magnetic core 30 may be provided in pairs to include a first magnetic core 31 disposed at the top of the housing 20 and a second magnetic core 32 disposed at the bottom of the housing 20. For example, the first and second magnetic cores 31 and 32 may be coupled to the housing 20 at the top and bottom of the housing 20, respectively. In FIG. 5, for the sake of convenience of explanation, detailed components only for the lower magnetic core 32 are illustrated with reference numerals.

A shape and a size of each of the first and second magnetic cores 31 and 32 may be determined based on a structure of a component (e.g., the housing) connected to the respective magnetic core 30, performance test of the inductor 1000, and the like.

For example, a first surface (e.g., a surface on which the first and second magnetic cores 31 and 32 are mutually connected to each other) of each of the magnetic cores 31 and 32 may be formed in a shape which is capable of surrounding at least a part of the housing 20. Each of the magnetic cores 31 and 32 may include a first protrusion p1 fitted to the opening hl of the housing 20, second protrusions p2 and p3 surrounding sides of the outer of the body b1 of the housing 20, and a flat surface f1 surrounding the top or bottom surface of the housing 20. For another example, a second surface (e.g., an opposite surface of the first surface) and a plurality of sides of each of the magnetic cores 31 and 32 may be, for example, an overall flat shape. As described above, the magnetic cores according to an embodiment may be formed in a shape which facilitates coupling and manufacturing of other components as well as satisfying performance of the inductor 1000.

According to an embodiment, the first and second magnetic cores 31 and 32 may be fixed to the housing 20 with an adhesive or a tape in a state of being connected to the housing 20.

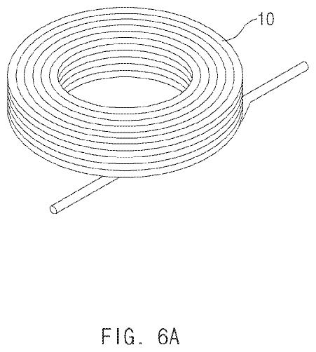

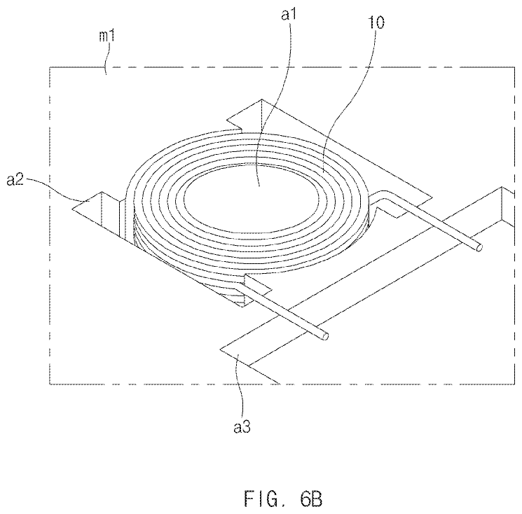

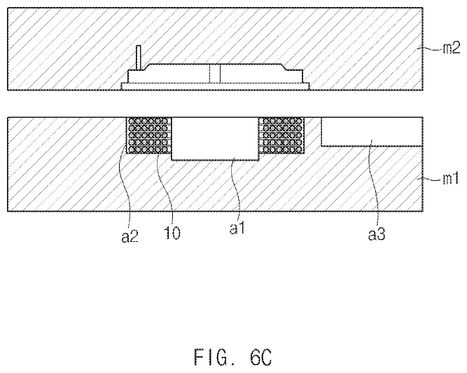

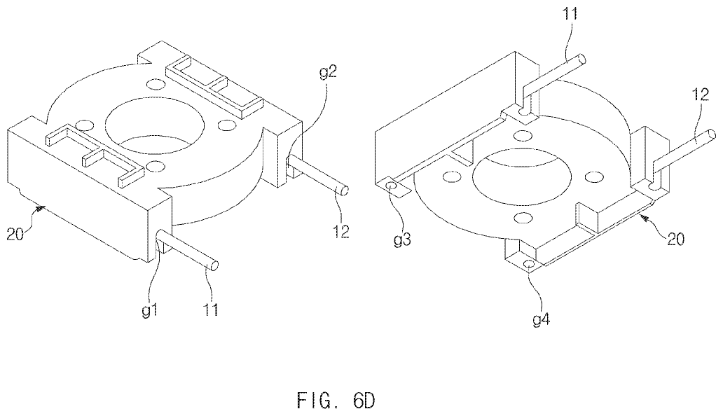

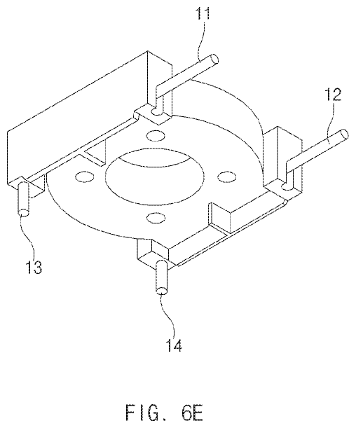

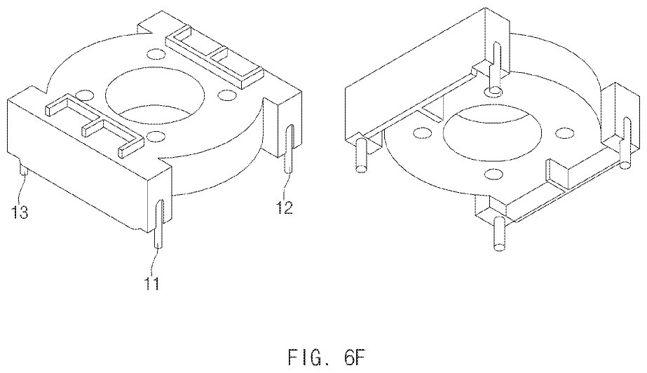

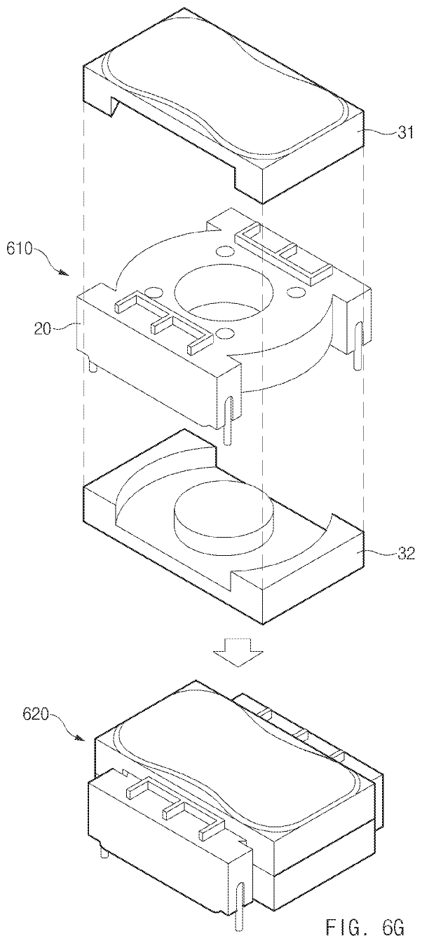

FIGS. 6A to 6G are views illustrating a method of manufacturing an inductor according to an embodiment of the disclosure. FIGS. 6A to 6G illustrate the case where the direction in which the opposite end portions 11 and 12 of the winding wire coupled to the housing 20 are protruded from the housing 20 is different from the mounting direction of the printed circuit board, as an example.

FIG. 6A is a perspective view of a winding wire according to an embodiment of the disclosure.

Referring to FIG. 6A, the winding wire 10 may be formed by winding the self-bonding wire using the frame member (e.g., a reel of an automatic winding machine) to have the specific length and then separating the conducting wire wound from the frame member. For example, in the winding wire 10, the at least a part of the rest of the winding wire 10 except for the opposite end portions 11 and 12 of the winding wire may have the donut shape and the opposite end portions 11 and 12 of the winding wire may be exposed to the outside of the donut shape to be spaced apart from each other by the specific distance

FIG. 6B illustrates a winding wire disposed in a first mold according to an embodiment of the disclosure.

Referring to FIG. 6B, the winding wire 10 may be seated in a first mold m1 and the opposite end portions 11 and 12 of the winding wire may be bent to be parallel to each other. The first mold m1, which is an upper mold or a lower mold of the mold, may include a first area a1, a second area a2 and a third area a3. For example, the first area a1 may include an area for forming the opening h1 in the center of the housing 20. For example, the second area a2 may include an area for forming at least a part of the rest of the housing 20. For example, the third area a3 may include an area for holding the opposite end portions 11 and 12 of the winding wire flat. A shape of the first mold may be easily derived from the shape of the housing 20 and the injection molding process by those skilled in the art, therefore a detailed description thereof will be omitted.

FIG. 6C illustrates first and second molds forming a housing according to an embodiment of the disclosure.

Referring to FIG. 6C, the first mold m1 in which the winding wire 10 is seated may be connected to a second mold m2. When the first mold m1 is the upper mold, the second mold m2 may be the lower mold. A shape of the second mold m2 may be easily derived from the shape of the housing 20 and the injection molding process by those skilled in the art, and therefore, a detailed description thereof will be omitted.

FIG. 6D is a top perspective view and a bottom perspective view of a housing according to an embodiment of the disclosure.

Referring to FIG. 6D, according to an embodiment, the housing 20 may be formed through the injection molding using the first and second molds ml and m2. For example, the housing 20 may be formed by connecting the first and second molds m1 and m2 to each other, in which the winding wire 10 is embedded, to generate a space, sealing the space, injecting the plastic resin into the sealed space, and solidifying the plastic resin. The injection molding may be performed at a temperature below the first melting point at which the sheath of the winding wire 10 is melted. The resin used in the injection molding may be a nonmagnetic polymer compound having a nonconductive property and may have a second melting point. Accordingly, a problem, that the sheath of the winding wire 10 is melted during the injection molding process, may be prevented. Further, a problem, that conductivity or magnetism of the housing 20 affects the performance of the inductor 1000, may be prevented.

In the housing 20 formed as shown in FIG. 6D, the opposite end portions 11 and 12 may be exposed to the outside of the housing 20 and the at least a part of the rest of the winding wire 10 except for the opposite end portions 11 and 12 of the winding wire may be fixed to the inside of the housing 20. The plurality of first grooves g1 and g2 and the at least one of the second grooves g3 and g4 may be formed in the corner regions of the housing 20. The plurality of first grooves g1 and g2 may be formed to have a shape and a size capable of seating the opposite end portions 11 and 12 of winding wire, which is bent-processed. The at least one of the second grooves g3 and g4 may be formed in a direction in which the inductor 1000 is mounted on the printed circuit board and the dummy pins 13 and 14 may be installed in the second grooves g3 and g4.

FIG. 6E is a bottom perspective view of a housing with dummy pins according to an embodiment of the disclosure. In an embodiment, when the inductor 1000 is fixed to the printed circuit board as the opposite end portions 11 and 12 of the winding wire are fixed to the printed circuit board, the process of FIG. 6E may be omitted.

Referring to FIG. 6E, according to an embodiment, the dummy pins 13 and 14 may be installed in the second grooves g3 and g4 of the housing 20. For example, the dummy pins 13 and 14 may be installed in the second grooves g3 and g4 of the housing 20 from the lower surface of the housing 20 to the upper surface of the housing 20. The dummy pins 13 and 14 may be soldered to the printed circuit board together with the opposite end portions 11 and 12 of the winding wire, and therefore the inductor 1000 according to an embodiment may be firmly fixed to the printed circuit board with the opposite end portions 11 and 12 of the winding wire. Although FIG. 6E shows a case where the number of the second grooves g3 and g4 and the dummy pins 13 and 14 corresponding to the number (two) of the opposite end portions 11 and 12 of the winding wire are provided, the second grooves g3 and g4 and the dummy pins 13 and 14 may not be limited thereto.

FIG. 6F is a view showing a process of bending opposite end portions of a winding wire according to an embodiment of the disclosure. The process of FIG. 6F may be omitted when the direction in which the opposite end portions 11 and 12 of the winding wire protrude from the housing 20 coincides with the mounting direction of the inductor 1000 according to an embodiment

Referring to FIG. 6F, according to an embodiment, the opposite end portions 11 and 12 of the winding wire may be bent in the mounting direction of the printed circuit board. For example, when the inductor 1000 is mounted on the printed circuit board in a direction from the top of the housing 20 to the bottom of the housing 20, the opposite end portions 11 and 12 of the winding wire may be bent by 90 degrees from a direction where the opposite end portions 11 and 12 of the winding wire protrude to the outside of the housing 20 to a downward direction of the housing 20, thereby heading for the bottom of the housing 20 (or the mounting direction to the printed circuit board).

According to an embodiment, the opposite end portions 11 and 12 of the winding wire may perform a first soldering to the printed circuit board before mounting on the printed circuit board. Thus, in an embodiment, soldering of the opposite end portions 11 and 12 of the winding wire after the opposite end portions 11 and 12 of the winding wire are mounted on the printed circuit board may be facilitated.

FIG. 6G is a view illustrating a coupling process of a housing and a magnetic core according to an embodiment of the disclosure.

Referring to FIG. 6G, according to an embodiment, in operation 610, the first and second magnetic cores 31 and 32 may be connected to the housing 20 at the top and bottom of the housing 20, respectively. The surfaces where the first magnetic core 31 and the second magnetic core 32 are mutually connected to each other may be bonded with an adhesive or the like.

In operation 620, the first and second magnetic cores 31 and 32 may be attached to the housing 20 by the adhesive, a tape or the like while being connected to the housing 20. For example, when connecting surfaces of the first and second magnetic cores 31 and 32 are bonded, the first and second magnetic cores 31 and 32 may be fixed to the housing 20 with the adhesive.

For another example, the first and second magnetic cores 31 and 32 may be fixed to the housing 20 with the tape or the like in a state of being connected to the housing 20.

As described above, in an embodiment, noise generation of the inductor, failure of the pin soldering, and damage of the winding wire due to the external factor may be prevented as compared with the conventional inductor. In addition, in an embodiment, the process of the inductor may be automated and simplified, thereby improving productivity and reducing the cost.

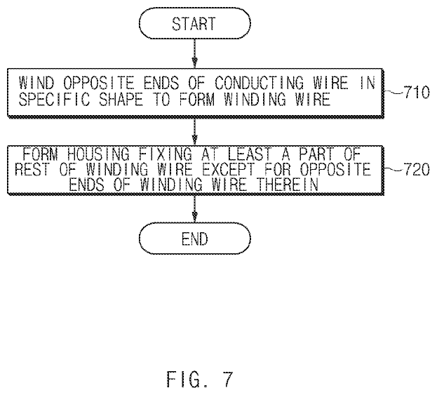

FIG. 7 is a flowchart illustrating a method of manufacturing an inductor according to an embodiment.

Referring to FIG. 7, in operation 710, the winding wire may be formed by winding the opposite end portions of the conducting wire in a specific shape. For example, each of the opposite end portions of the winding wire may be a region having a specific length from each of opposite edge surfaces of the winding wire.

In operation 720, the housing may be provided such that the at least a part of the rest of the winding wire except for the opposite end portions may be fixed to the housing therein. The providing of the housing may include seating the at least a part of the rest of the winding wire inside the mold such that the opposite end portions of the winding wire are exposed and performing injection molding using the mold, which includes the winding wire.

According to an embodiment, the inductor (e.g., the inductor 1000 of FIG. 1) may include a winding wire that has a specific shape and a housing that exposes opposite end portions of the winding wire and to fix at least a part of a rest of the winding wire in the housing. Each of the opposite end portions may be a region having a specific length from each of opposite edge sides of the winding wire, and the housing may include a nonmagnetic material having a nonconductive property.

The winding wire may wind a self-bonding conducting wire in the specific shape to expose the opposite end portions of the winding wire. The opposite end portions of the winding wire may be mounted on a printed circuit board to be soldered to the printed circuit board. The opposite end portions of the winding wire may be soldered before being mounted on the printed circuit board. The opposite end portions of the winding wire may be bent in a mounting direction of the printed circuit board when the opposite end portions of the winding wire protrude toward a direction different from the mounting direction of the printed circuit board.

According to an embodiment, the inductor may further include a dummy pin and the dummy pin may be installed in at least one groove formed at a corner region of the housing where the opposite end portions of the winding wire are not disposed such that the inductor is fixed to a printed circuit board.

The winding wire may include a sheath made of a material having a first melting point, the housing may be made of a material having a second melting point, the second melting point may be less than the first melting point, and injection molding may be performed at a temperature above the second melting point and below the first melting point.

According to an embodiment, the inductor may further include a magnetic core that is fixed to the housing to be spaced away from the opposite end portions of the winding wire.

According to an embodiment, the method of manufacturing the inductor may include forming a winding wire by winding a conducting wire to have a specific shape and forming a housing fixing at least a part of a rest of the winding wire except for opposite end portions of the winding wire in the housing. Each of the opposite end portions may be a region having a specific length from each of opposite edge sides of the winding wire, and the forming of the housing may include seating the at least a part of the rest of the winding wire in a mold to expose the opposite end portions of the winding wire; and performing injection molding using the mold, which includes the winding wire.

The forming of the winding wire may include winding a self-bonding wire using a frame having the specific shape; and separating the winding wire from the frame having the specific shape.

When the opposite end portions of the winding wire protrude from the housing toward a direction different from the mounting direction of the printed circuit board, the method of manufacturing the inductor may further include bending the opposite end portions of the winding wire in a mounting direction of a printed circuit board to be seated in a plurality of grooves formed in the housing; and bonding the opposite end portions of the winding wire seated in the plurality of grooves to the housing.

According to an embodiment, the method of manufacturing the inductor may further include soldering the opposite end portions of the winding wire before being mounted on a printed circuit board.

The forming of the housing may include positioning the at least a part of the rest of the winding wire inside the mold, injecting resin, which is molten at a temperature less than a melting point of a sheath of the winding wire, into an inner space of the mold, and solidifying the molten resin.

According to an embodiment, the method of manufacturing the inductor may further include installing at least one dummy pin in at least one groove formed at a corner region where the opposite end portions of the winding wire are not disposed.

According to an embodiment, the method of manufacturing the inductor may further include covering at least a part of the housing using a magnetic core to be spaced away from the opposite end portions of the winding wire.

The embodiments of the disclosure are presented for the purpose of explanation and understanding of the disclosed contents, and are not intended to limit the scope of the invention described herein. Accordingly, the scope of this disclosure should be interpreted to include all modifications based on the technical idea of this disclosure or various other embodiments.

1. An inductor, comprising:
a winding wire configured to have a specific shape; and
a housing configured to expose opposite end portions of the winding wire and to fix at least a part of a rest of the winding wire in the housing, and
wherein each of the opposite end portions is a region having a specific length from each of opposite edge sides of the winding wire, and
wherein the housing includes a nonmagnetic material having a nonconductive property.

2. The inductor of claim 1, wherein the winding wire is configured to wind a self-bonding conducting wire in the specific shape to expose the opposite end portions of the winding wire.

3. The inductor of claim 1, wherein the opposite end portions of the winding wire are mounted on a printed circuit board to be soldered to the printed circuit board.

4. The inductor of claim 3, wherein the opposite end portions of the winding wire are soldered before being mounted on the printed circuit board.

5. The inductor of claim 3, wherein the opposite end portions of the winding wire are bent in a mounting direction of the printed circuit board the opposite end portions of the winding wire protrude toward a direction different from the mounting direction of the printed circuit board.

6. The inductor of claim 1, further comprising:
a dummy pin,
wherein the dummy pin is installed in at least one groove formed at a corner region of the housing where the opposite end portions of the winding wire are not disposed such that the inductor is fixed to a printed circuit board.

7. The inductor of claim 1, wherein the winding wire includes a sheath made of a material having a first melting point,
wherein the housing is made of a material having a second melting point and the second melting point is less than the first melting point, and
wherein injection molding is performed at a temperature above the second melting point and below the first melting point.

8. The inductor of claim 1, further comprising:
a magnetic core configured to be fixed to the housing to be spaced away from the opposite end portions of the winding wire.

9. A method of manufacturing an inductor, the method comprising:
forming a winding wire by winding a conducting wire to have a specific shape; and
forming a housing fixing at least a part of a rest of the winding wire except for opposite end portions of the winding wire in the housing,
wherein each of the opposite end portions is a region having a specific length from each of opposite edge sides of the winding wire,
wherein the forming of the housing includes:
seating the at least a part of the rest of the winding wire in a mold to expose the opposite end portions of the winding wire; and
performing injection molding using the mold, which includes the winding wire.

10. The method of claim 9, wherein the forming of the winding wire includes:
winding a self-bonding wire using a frame having the specific shape; and
separating the winding wire from the frame having the specific shape.

11. The method of claim 9, further comprising:
bending the opposite end portions of the winding wire in a mounting direction of a printed circuit board to be seated in a plurality of grooves formed in the housing; and
bonding the opposite end portions of the winding wire seated in the plurality of grooves to the housing,
when the opposite end portions of the winding wire protrude from the housing toward a direction different from the mounting direction of the printed circuit board.

12. The method of claim 9, further comprising:
soldering the opposite end portions of the winding wire before being mounted on a printed circuit board.

13. The method of claim 9, wherein the forming of the housing includes:
positioning the at least a part of the rest of the winding wire inside the mold;
injecting resin, which is molten at a temperature less than a melting point of a sheath of the winding wire, into an inner space of the mold; and
solidifying the molten resin.

14. The method of claim 9, further comprising:
installing at least one dummy pin in at least one groove formed at a corner region where the opposite end portions of the winding wire are not disposed.

15. The method of claim 9, further comprising:
covering at least a part of the housing using a magnetic core to be spaced away from the opposite end portions of the winding wire.
